(19) United States
(12) Patent Application Publication
(10) Pub. No.: US 2008/0211735 A1
(43) Pub. Date: Sep. 4, 2008

(54) Rear Seat Entertainment System

(76) Inventors: Mark Balcerzak, Rochester Hills, MI (US); Victor Claude Evjen, Highland, MI (US)

Correspondence Address: MAGNA INTERNATIONAL, INC., 337 MAGNA DRIVE, AURORA, ON, L4G-7K1, CA

(21) Appl. No.: 12/088,989

(22) PCT Filed: Oct. 3, 2006
(86) PCT No.: PCT/US06/38328

§ 371 Date: Apr. 2, 2008

Related U.S. Application Data
(60) Provisional application No. 60/723,223, filed on Oct. 3, 2005.

(51) Int. Cl. G09G 5/00

(52) U.S. Cl. 345/3.1

(57) ABSTRACT

A rear seat entertainment system (50) is disclosed. The rear seat entertainment system (50) includes a rear view imaging device (54) that captures one or more images (I) behind a vehicle (10) and a display device (52) including a first viewing surface (58) and a second viewing surface (60). The first viewing surface (58) displays one or more images in a first line of sight (L1) to one or more rear seat occupants (R). The second viewing surface (60) displays one or more images (I) within a second line of sight (L2) to a vehicle operator (F).

### TECHNICAL FIELD

The invention generally relates to rear seat entertainment systems, and in particular, to a rear seat entertainment system including a display screen and rear view imaging device that maintains the rear-view mirror line of sight for the vehicle operator while increasing the surface area of the display screen.

### BACKGROUND

Since the introduction of what is known as the modem day automobile in the late 1800's, families or groups of two or more persons have embarked on cross-country vacations or “road trips” in their vehicles that may take up to a few hours, a day, or a week of time. Accordingly, one or more passengers, often children, are seated in the rear area of vehicle in what is known as the second, third, or n^{th} row. When children are located in this area of the vehicle, parents or caretakers are usually charged with keeping the children under control and occupied so that restlessness, tantrums, or other unruly behaviour does not create an unpleasant experience for all who are seated in the vehicle. More often than not, parents or caretakers are often barraged in one form or another with the children incessantly querying: “Are we there yet?”

In the mid-to-late 1990's advances in technology have provided a solution for this problem with the invention of the rear seat entertainment (RSE) device. In the early 2000's, RSE devices have become a ubiquitous feature in most minivans, sport utility vehicles (SUVs), or the like. As is known in the art, RSE devices typically include visual and audio capabilities that are provided by a display screen and speakers. Some RSE devices also have an input device, which may include, for example, a remote control, one or more video game control pads, or the like. Because the rear seat passengers, often children, are now occupied with their favorite movie, television program, video game, or the like, parents or caretakers are typically not interrupted as frequently, or ever, during the traveling period in the vehicle.

It is known that conventional display screens for RSE devices may include an electrically-powered flat-panel display, such as a liquid crystal display (LCD) or plasma screen. Alternatively, it is known that the display screen may be a conventional projection surface that receives a projected image from a projector. Such RSE display screens may be an original equipment manufacturer (OEM) installed component, or, alternatively, an after-market component. Referring to FIG. 1, a common location for installing a display screen 1 is adjacent a headliner 2, just behind the front row seating positioning 3 of the vehicle operator, F.

Although adequate for most applications, such RSE display screens 1 that are located adjacent the headliner 2 have been limited to a very small dimension such that the rear-view mirror line of sight, which is generally shown at reference numeral 4, for the vehicle operator, F, is not obstructed. As seen in FIG. 1, when the display screen 1 is stowed adjacent/in the headliner 2, the rear-view mirror line of sight 4 is not obstructed. However, even when the display screen 1 is in the up or stowed position, the rear-view mirror line of sight 4 may be obstructed by heads of passengers, fogged windows, defroster grid and/or antenna lines printed on the window glass, B-pillars, C-pillars, or the like.

Even further, if the display screen 1 is shifted to the down or deployed position, some or all of the rear-view mirror line of sight 4 may be obstructed. As such, the viewing surface for most display screens 1 are typically restricted to a dimension that is less than or equal to a seven-inch diagonal, thereby preventing larger viewing surfaces for (a) rear seat passenger(s).

Accordingly, a need therefore exists for an apparatus that maintains the rear- view mirror line of sight for the vehicle operator. Additionally, a need also exists for an apparatus that increases the surface area of the RSE display screen.

### BRIEF DESCRIPTION OF THE DRAWINGS

The present disclosure will now be described, by way of example, with reference to the accompanying drawings, in which:

FIG. 1 is a partially broken, side environmental view of a conventional RSE system with the display screen in a stowed position;

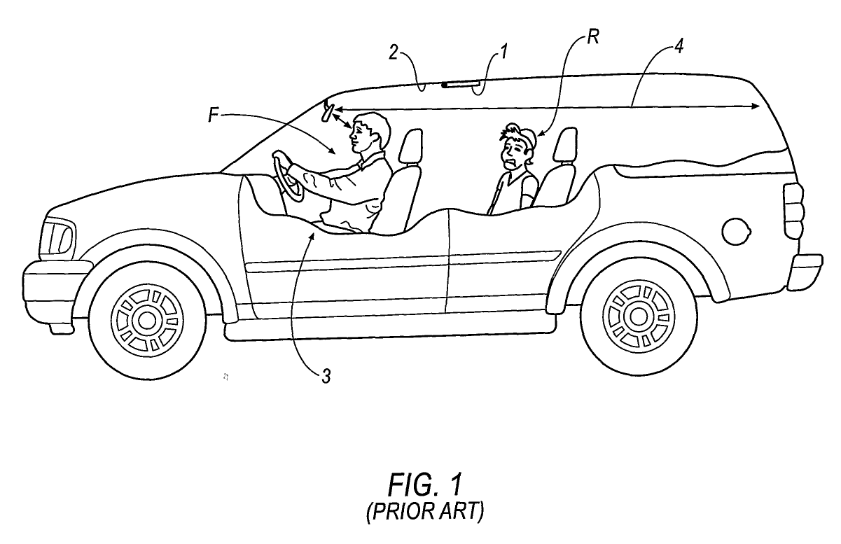

FIG. 2 is a partially broken, side environmental view of a RSE system according to an embodiment;

FIG. 3A is a partially broken, side environmental view of the RSE system of FIG. 2 according to an embodiment; and

FIG. 3B is a partially broken, side environmental view of the RSE system of FIG. 2 according to an embodiment.

### DESCRIPTION OF THE PREFERRED EMBODIMENT

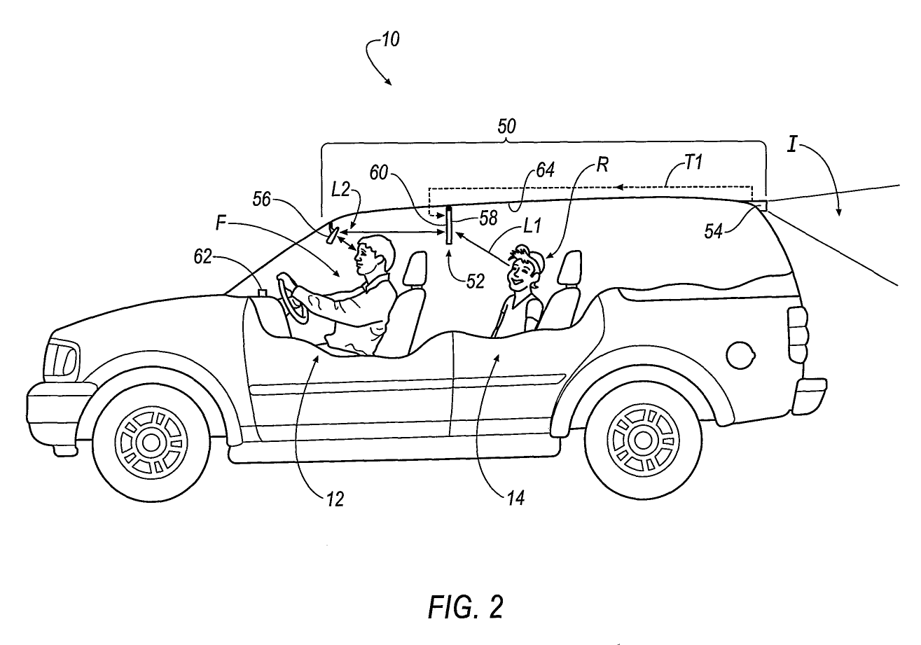

Referring to FIG. 2, a partially broken side view of a vehicle is shown generally at 10 having a front seating area 12 where a vehicle operator or front seat occupant, F, is positioned and a rear seating area 14 where (a) rear seat occupant(s), R, is/are positioned. According to an embodiment, the vehicle 10 includes a rear seat entertainment (RSE) system, which is shown generally at 50 and includes a display screen 52, a rear view imaging device 54, and a rear view mirror 56.

According to an embodiment, the display screen 52 includes a first viewing surface, which is shown generally at 58, and a second viewing surface, which is shown generally at 60. The first viewing surface 58 provides images for viewing by the rear seat occupant(s), R, along a rear seat occupant line of sight, L1, while the second viewing surface 60 provides images for viewing by the vehicle operator or front seat occupant, F, along a rear view mirror line of sight, L2. As illustrated, the rear view mirror line of sight, L2, is a reflected image sight line viewed by the vehicle operator, F, of the second viewing surface 60 as determined by the positioning/angle of the rear view mirror 56. The line of sight, L2, may also comprise any desirable rear line of sight, such as, the line of sight that is available through the imaging device 54, which may include at least the view through the rear window of the vehicle. Because the display screen 52 has a first and second viewing surface 58, 60, the display screen 52 may essentially be referred to as a “doubled-sided display device.” If, for example, the display screen 52 comprises an LCD or plasma display, the display screen 52 may include two LCD screens or plasma screens, one of which is disposed, respectively, on each first and second viewing surface 58, 60.

The first viewing surface 58 may display, for example, a movie, television program, video game, or the like for viewing by the rear seat occupant(s), R, along the line of sight, L1. The second viewing surface 60, however, may display, for example, (an) image(s) captured by the rear view imaging device 54. Generally, as illustrated in FIG. 2, the rear view image(s), which is/are shown generally at reference numeral I, is/are transferred along a communication path, which is shown generally at T1, from the rear view imaging device 54 to the second viewing surface 60 of the display screen 52. To provide clearly defined rear view image(s), I, for an unobstructed rear view to the vehicle operator, F, it is preferable to position the rear view imaging device 54 proximate the rear end of the vehicle 10, which may be exterior to, or, in the interior of the vehicle 10 near the rear of the vehicle 10.

It will be appreciated that the rear view imaging device 54 may be a conventional camera that captures discrete images or a series of images at a frame rate that forms a stream of real-time video. If desired, the rear view imaging device 54 may include night vision capabilities if the rear area of the vehicle 10 is not adequately illuminated during night time driving. According to an embodiment, a switch or dial 62 may be disposed within reach of the vehicle operator, F, proximate the instrument panel cluster, for switching to and from the night vision application. However, it will be appreciated that the RSE system 50 may include a sensor that automatically activates or deactivates the night vision feature, based upon the exterior illumination conditions of the vehicle. Additionally, the rear view imaging device 54 may be tuned for focal length variations to present a panoramic view of the environment behind the vehicle 10. The tuning of the rear view image(s), I, may be automatically carried out by logic, or alternatively, in a manual fashion with the switch or dial 62, as desired.

Once the rear view image(s), I, is/are received by the display screen 52, the rear view image(s), I, is/are displayed on the second viewing surface 60. Accordingly, by bypassing obstructions other than the display screen 52 in the passenger compartment, such as, for example, the fogged windows, defroster grid and/or antenna lines printed on the window glass, B-pillars, C-pillarsor, and/or (a) head(s) of rear seat occupant(s), R, the rear view line of sight, L2, is not interrupted as compared to conventional RSE systems. Even further, because the rear view line of sight, L2, is no longer interrupted, it will be appreciated that the display screen 52 may be enlarged (on both first and second viewing surfaces 58, 60) so as to provide a “big screen” effect such that the rear and front seat occupants, R, F, may enjoy the benefit of (a) larger image(s) on the display screen 52. Accordingly, by bypassing such obstructions, and by increasing the size of the rear view image, I, on the second viewing surface 60, a clear and easily discernable image of the environment behind the vehicle 10 may be presented to the vehicle operator, F.

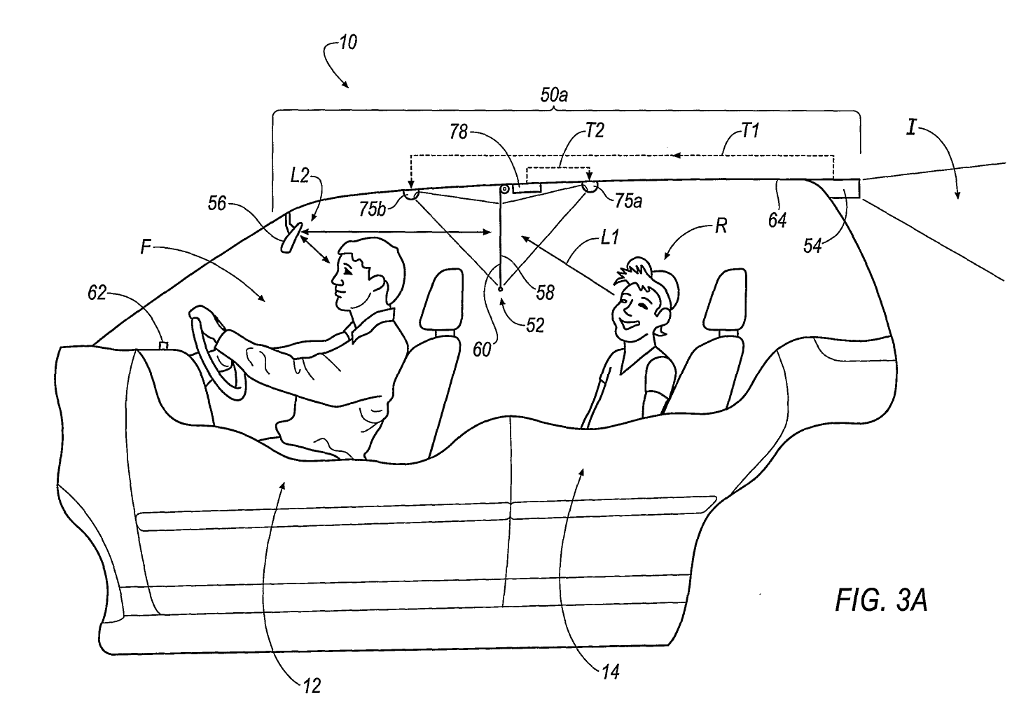

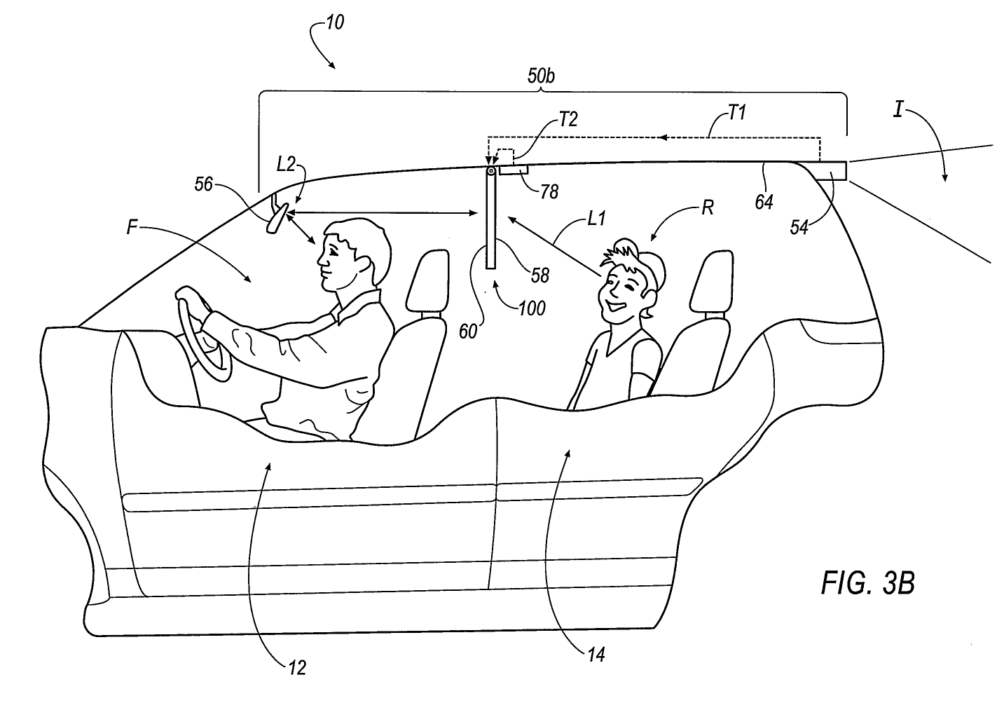

Referring to FIG. 3A, a RSE system is shown generally at 50a according to an embodiment. The RSE system 50a generally includes a projected image-type system such that projectors 75a, 75b provide (an) image(s) onto the first and second viewing surface 58, 60, respectively. As illustrated, an entertainment component 78, such as, for example, a television receiver, digital video disc (DVD) player, video game console, or the like, provides (an) image(s) to the projector 75a over a communication path, T2, while the rear view imaging device 54 provides (an) image(s) to the projector 75b over the communication path, T1, as described above.

Referring to FIGS. 3B, a RSE system is shown generally at 50b according to an embodiment. The RSE system 50b generally includes a flat panel display-type system including a double-sided LCD or plasma screen 100, as described above, that provides (an) image(s) onto the first and second viewing surfaces 58, 60, respectively. As illustrated, the entertainment component 78 provides (an) image(s) to the first viewing surface 58 of the double-sided flat panel screen 100 over the communication path, T2, while the rear view imaging device 54 provides (an) image(s) to the second viewing surface 60 of the double-sided flat panel screen 100 over the communication path, T1.

Although the RSE systems 50a, 50b are shown to exclusively include a projection-type system and a double-sided flat panel display system, respectively, it will be appreciated that a RSE system 50 may include a hybrid-type system in that, for example, a conventional, single-sided flat panel screen is utilized for presenting (an) image(s) to one of the rear seat occupant(s), R, or vehicle operator, F, while the opposite/rear side of flat panel screen is utilized for receiving (a) projected image(s) from a projector. Even further, it will be appreciated that the communication paths T1, T2 may transmit signals over a hard-wired path or a wireless path, as desired. Also, the display screen may be rigid, such that it is deployed a pivoting manner to and from the headliner 64, or, alternatively, from a tube such that the display screen 52 is rolled from the headliner 64 if applied in a projected image-type system.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A rear seat entertainment system (50), comprising:
a rear view imaging device (54) that captures one or more rear view images (I) behind a vehicle (10); and
a display device (52) including a first viewing surface (58) and a second viewing surface (60), wherein the first viewing surface (58) displays one or more images in a first line of sight (L1) to one or more rear seat occupants (R), wherein the second viewing surface (60) displays one or more images (I) within a second line of sight (L2) to a vehicle operator (F).

2. The rear seat entertainment system (50) according to claim 1, wherein the display device (52) is a liquid crystal display or plasma flat panel screen.

3. The rear seat entertainment system (50b) according to claim 2, wherein the display device (52) is a doubled-sided flat panel screen (100) including two screens, one of which is disposed, respectively, on each first and second viewing surface (58, 60).

4. The rear seat entertainment system (50a) according to claim 1, wherein the display device (52) is projection screen receiving one or more projected images on the first viewing surface (58) from a first projector (75 a) and the one or more images (I) on the second viewing surface (60) from a second projector (75b).

5. The rear seat entertainment system (50) according to claim 1, wherein the rear view imaging device (54) is positioned exterior to vehicle (10).

6. The rear seat entertainment system (50) according to claim 1, wherein the rear view imaging device (54) is positioned interior of vehicle (10).

7. The rear seat entertainment system (50) according to claim 1, wherein the one or more images (I) are wirelessly transmitted over a communication path (T1) from the rear view imaging device (54) to the second viewing surface (60) of the display device (52).

8. The rear seat entertainment system (50) according to claim 1, wherein the one or more images (I) are transmitted over a hardwired communication path (T1) from the rear view imaging device (54) to the second viewing surface (60) of the display device (52).

9. The rear seat entertainment system (50) according to claim 1, wherein the rear view imaging device (54) is a camera that captures discrete images or a series of images at a frame rate that forms a real-time video stream.

10. The rear seat entertainment system (50) according to claim 9, wherein the camera includes a night vision feature.

11. The rear seat entertainment system (50) according to claim 10 further comprising a button or dial that may activate and deactivate the night vision feature.

12. A rear seat entertainment system (50a), comprising:
a rear view imaging device (54) that captures one or more rear view images (I) behind a vehicle (10); and
a display device (52) including a first viewing surface (58) and a second viewing surface (60), wherein the first viewing surface (58) displays one or more images in a line of sight (L1) to one or more rear seat occupants (R), wherein the second viewing surface (60) displays a reproduction of the one or more rear view images (I) in a rear view line of sight (L2) of a rear view mirror (56) to the vehicle operator (F), wherein the display device (52) is projection screen that receives one or more projected images on the first viewing surface (58) from a first projector (75a) and the one or more rear view images (I) on the second viewing surface (60) from a second projector (75b).

13. The rear seat entertainment system (50a) according to claim 12, wherein the rear view imaging device (54) is positioned exterior to vehicle (10).

14. The rear seat entertainment system (50a) according to claim 12, wherein the rear view imaging device (54) is positioned interior of vehicle (10).

15. The rear seat entertainment system (50a) according to claim 12, wherein the one or more rear view images (I) are wirelessly transmitted over a communication path (T1) from the rear view imaging device (54) to the second viewing surface (60) of the display device (52).

16. The rear seat entertainment system (50a) according to claim 12, wherein the one or more rear view images (I) are transmitted over a hardwired communication path (T1) from the rear view imaging device (54) to the second viewing surface (60) of the display device (52).

17. A rear seat entertainment system (50b), comprising:
a rear view imaging device (54) that captures one or more rear view images (I) behind a vehicle (10); and
a display device (52) including a first viewing surface (58) and a second viewing surface (60), wherein the first viewing surface (58) displays one or more images in a line of sight (L1) to one or more rear seat occupants (R), wherein the second viewing surface (60) displays a reproduction of the one or more rear view images (I) in a rear view line of sight (L2) of a rear view mirror (56) to the vehicle operator (F), wherein the display device (52) is a doubled-sided flat panel screen (100) including two screens, one of which is disposed, respectively, on each first and second viewing surface (58, 60).

18. The rear seat entertainment system (50b) according to claim 17, wherein the rear view imaging device (54) is positioned exterior to vehicle (10).

19. The rear seat entertainment system (50b) according to claim 17, wherein the rear view imaging device (54) is positioned interior of vehicle (10).

20. The rear seat entertainment system (50b) according to claim 17, wherein the one or more rear view images (I) are wirelessly transmitted over a communication path (T1) from the rear view imaging device (54) to the second viewing surface (60) of the display device (52).

21. The rear seat entertainment system (50b) according to claim 17, wherein the one or more rear view images (I) are transmitted over a hardwired communication path (T1) from the rear view imaging device (54) to the second viewing surface (60) of the display device (52).

22. A rear seat entertainment system (50), comprising:
a rear view imaging device (54) that captures one or more rear view images (I) behind a vehicle (10); and
a display device (52) including a first viewing surface (58) and a second viewing surface (60), wherein the first viewing surface (58) displays one or more images in a line of sight (L1) to one or more rear seat occupants (R), wherein the second viewing surface (60) displays a reproduction of the one or more rear view images (I) in a rear view line of sight (L2) of a rear view mirror (56) to the vehicle operator (F), wherein the display device (52) includes one liquid crystal display or plasma screen for either the first or second viewing surface (58, 60), wherein an opposite, rear side of the liquid crystal display or plasma screen serves as a projection screen receiving one or more projected images from a projector (75) and acts as the other first or second viewing surface (58, 60).
